(19) United States
(12) Patent Application Publication
(10) Pub. No.: US 2026/0286070 A1
(43) Pub. Date: Sep. 24, 2026

(54) Processing aid, and method for obtaining a processing aid

(71) Applicant: DEVINOCHEM GmbH & Co. KG, Wiesbaden (DE)

(72) Inventors: Falk Gabel, Schlangenbad (DE); Christian Barbe, Schlangenbad (DE); Florian Roth, Schlangenbad (DE)

(73) Assignee: Devinochem GmbH & Co. KG, Wiesbaden (DE)

(21) Appl. No.: 19/569,265

(22) Filed: Mar. 17, 2026

Related U.S. Application Data
(60) Provisional application No. 63/773,908, filed on Mar. 18, 2025.

(30) Foreign Application Priority Data
Mar. 18, 2025 (DE) 102025110380.1

(51) Int. Cl. C08J 3/22; C08K 5/053; C08K 5/098; C08K 5/20; C08L 3/00; C08L 29/04

(52) U.S. Cl. CPC C08J 3/226; C08K 5/053; C08K 5/098; C08K 5/20; C08L 3/00; C08L 29/04; C08J 2303/00; C08J 2329/04; C08J 2403/00; C08J 2471/02; C08J 2497/00; C08L 2205/02; C08L 2205/03; C08L 2205/035; C08L 2205/06; C08L 2310/00

(57) ABSTRACT

The present disclosure relates to processing aids, in particular for producing products from or comprising rubber mixtures and/or other organic polymers, for example for producing so-called elastomers.

### TECHNICAL FIELD

The present disclosure generally relates to processing aids, in particular to film-forming processing aids, particular to processing aids, such as film-forming processing aids, for use in the production of products from or comprising rubber mixtures and/or other organic polymers, for example for producing so-called elastomers. More particularly, the present disclosure relates to a processing aid which provides for a good demolding and/or separation effect of products produced from or comprising rubber mixtures and/or other polymers, while also enabling improved application, in particular with regard to safety aspects and costs. The processing aid of the disclosure is furthermore particularly suited to provide for a good demolding and/or separation effect of products even for varying production and/or storage conditions of the products from or comprising rubber mixtures and/or other organic polymers, for example for producing so-called elastomers, that is, provides a good and long-term demolding and/or separation effect even for varying pressures, temperatures and mechanical stress, such as deformation of the product(s) onto which the processing aid has been applied. In the sense of the disclosure, generally, when reference is made to the effect of the processing aid/the processing aid coating layer, this effect will be referred to as “anti-tack effect” for short. It is understood that this refers, in the sense of the disclosure, to the anti-tacking/anti-sticking/demolding/lubricant/separation effect as described above that is observed and achieved for processing aid coating layers obtained or obtainable with the processing aid of the disclosure.

The present disclosure further also relates to a method for producing the processing aid, and to a processing aid produced or at least producible in this way.

In the context of the present disclosure, “processing aid master batch” refers to a processing aid with a high concentration in active ingredients and a low content in liquid, especially a low content in a liquid or a mixture of liquids used as diluent, such as water, with the liquid content usually being below 20%, based on weight, with reference to the total of the processing aid (total of weight of active ingredients and diluent(s), or even less, for example less than 15% based on weight. This means that the processing aid master batch (master batch for short) may come in the form of a powder and/or granules. The processing aid master batch may be particularly well suited for shipping, and may be diluted by the end user by adding a liquid phase or medium, usually water, as diluent, to obtain a processing aid dilution, which may in turn be used to obtain a processing aid coating layer or coating film, that is, preferably, a thin (preferably at most 10 μm, in particular, at most 5 μm), polymeric, and flexible with regard to dimensional changes film applied onto the surface of a substrate to modify its physicochemical properties. In the sense of the disclosure, a continuous film, which is a preferred embodiment of the processing aid coating layer or film, is understood to refer to a film that covers the whole of the area of the substrate in which it has been applied, preferably without any uncoated subareas, cracks or delamination. In the scope of the disclosure, “coating layer” and “coating film” are used as synonyms and refer to a layer applied onto the surface of a substrate at least in an area of that substrate.

In the context of the present disclosure, the processing aid may be, generally, without being limited to any of the embodiments and examples discussed in this disclosure, be a film-forming processing aid, that is, a processing aid suited for being applied to a surface of a substrate to form a coating layer or coating film on said substrate surface. Said coating layer may also generally be referred to, in the scope of the disclosure, as a processing aid coating layer or processing aid coating film or, short, coating layer or coating film, or even simply “coating” or “film”. It is understood that in the sense of the disclosure, “film” does not refer to a stand-alone film, but that the film of the disclosure is a material layer applied to a surface of a substrate, in particular to the surface of a substrate that may undergo changes in its geometric dimensions during processing and storage, i.e. compression, elongation, reduction in thickness with an increase in dimensions, and which generally is a product from or comprising rubber mixtures and/or other organic polymers, for example for producing so-called elastomers.

Processing aids with a specific functional character may also be referred to as release agents, lubricants, anti-friction agents, anti-stick agents, demolding agents, product separation agents, or the like, depending on their function. These terms usually, but not necessarily, describe processing aids which are already provided in a ready-to-use delivery form.

In the context of the present disclosure, powder is understood to mean a delivery form which substantially consists of particles, while particles also encompass aggregates and agglomerates. The term powder component refers to inorganic phases as well as to organic phases or mixtures of organic and inorganic phases, which are preferably provided in particulate form.

### BACKGROUND

As stated, the present disclosure generally relates to a processing aid which can be used, for example, as a demolding agent or release agent, as well as to a processing aid produced or producible from this formulation. The processing aid according to the disclosure can be used, for example, in the form of a coating so that a coating layer, preferably a flexible coating layer, is obtained. The coating layer has the effect of a release agent, and release agent is understood here to mean that it has the effect of keeping adjacent materials separable. In other words, the processing aid in this case can be understood as an agent with lubricant-like properties and/or which results in coating layers that have such properties, and can also generally be understood as a lubricant and/or as a means to obtain coating layers with such properties. This also applies, mutatis mutandis, with respect to demolding and/or anti-tack, and/or anti-friction agent, and/or product separation properties of the processing aid and/or the processing aid coating layer. Lubricants, or synonymously lubricating agents, are used for lubrication purposes and serve to reduce the sticking together or adhesion of surfaces to one another, hereinafter also referred to as adherence, but also to reduce friction and wear, and also for cooling purposes, for example by reducing frictional heat. The processing aid and/or the coating layer obtained from the processing aid may also be implemented as a mold release agent or demolding agent, i.e. as a processing aid/processing aid coating layer that prevents or at least reduces or minimizes the adhesion of cast and/or molded parts to the mold or, more generally, to a material that is used in the molding process. Furthermore, the processing aid and/or the corresponding processing aid coating layer according to the present disclosure can also act or be used as a lubricant, which is understood to mean in particular that it has a separating effect between hot surfaces or materials, for example so as to prevent a polymer melt from adhering to a hot metal surface such as the surface of a mold or of a tool. However, more generally, the processing aid and/or the corresponding processing aid coating layer can also be effective as a product release agent, for example as a product release agent that prevents the sticking of bulk material, granules and/or other preforms of a final product, in particular a polymeric final product. Generally, these aforementioned and non-exhaustive specific embodiments are subsumed under the term “processing aid” in the context of the present disclosure, which can in particular be a separating agent here under the general generic term of a processing aid, in particular a processing aid having a separating effect (or anti-tack effect, in the sense of the disclosure, as defined above) and that preferably demonstrates its effectiveness regardless of specific process parameters such as temperature, heating and cooling rates, pressures, atmospheres, and/or other unwanted process parameters such as deviations from target values and even contamination of substrate surfaces.

A specific embodiment of a processing aid within the meaning of the present disclosure can be understood as a demolding agent (synonym: release agent). The processing aid of the disclosure can be used, for example, as a processing aid in the manufacture of products from or comprising rubber mixtures and/or from or comprising other organic polymers. Processing aids in the form of demolding agents include, for example, agents which are applied to the surface of the product produced from or comprising a rubber mixture and/or produced from or comprising a polymer, or onto a mold that is used to produce the product. The film of processing aid applied is usually referred to as a release agent film. In the context of the present disclosure, this applied film can also be referred to and/or understood as a coating or layer. Furthermore, in the sense of the disclosure, when reference is made to a film-forming agent, it is understood that this refers to an agent that ensures a coating layer or coating film is obtained, preferably so that the resulting coating layer or coating film has a high flexibility and/or is crack free and/or has a high adherence to the substrate, preferably even when applying a mechanical stress to it, for example by bending or stretching of a flexible substrate, such as a polymer product or an elastomer or a rubber, to which it has been applied to. The purpose of the processing aid, for example of the demolding agent or release agent, is to prevent the produced product from adhering to the mold and/or to another similar product. It is also possible for the product to be in the form of a long strip which is stacked or rolled for storage, and in this case the different layers of the material should also not adhere to each other. This particular embodiment is mentioned here by way of example and represents a common embodiment or application of the processing aid according to the disclosure, so that many properties of the processing aid will be described further below with reference to this particular embodiment of the demolding or release agent. However, the application of the processing aid is by no means limited to this application, rather it can also be used in other areas, as explained in detail above.

Processing aids of the state of the art address user safety and processability of the processing aid as well as sustainability of the components of such a processing aid. For example, processing aids of the state of the art are often shipped in the form of a master batch that may be used by the end user to obtain a processing aid that is easier to be applied, usually by adding a liquid phase, in particular, a diluent, such as water, to the master batch and mixing.

While the processing aid master batch and the processing aid dilution both comprise the same active ingredients in the same amounts relative to each other, they thus differ from each other in terms of liquid content, that is, diluent content, especially in water content. In particular, the processing aid master batch has a much higher concentration of the active ingredients and a very low concentration of a diluent, such as water, while the processing aid dilution may be obtained from the processing aid master batch by adding a liquid phase or liquid diluent (or medium), usually water, and by mixing the active ingredients and the added liquid phase/diluent/medium, usually by introducing shear energy and/or by ensuring circulation and flow profiles that are created by a flow of the liquid phase/diluent (or medium) within a container and against a container wall so that a suspension and/or dispersion of the active ingredients in the liquid is obtained.

In the scope of the present disclosure, a diluent is understood to refer to a liquid medium used for dilution of the active ingredients. A particularly well suited diluent in the sense of the disclosure is, generally, without being limited to any specific embodiment, water.

Within the scope of the present disclosure, it is understood that the term of “processing aid” is used to designate both a master batch comprising the active ingredients and only a minor amount of a liquid phase, in particular, only a minor amount of diluent, such as water, as well as for the dilution of the master batch.

Processing aids of the state of the art are for example disclosed in WO 2024/214398 A1, US 2024/0067903 A1, US 2023/0151183 A1, U.S. Pat. No. 11,692,092 B2, and JP 2020/041089 A.

Problems encountered in processing aids of the state of the art are that the current processing aids result in coating films that may not show a sufficient anti-sticking effect, especially with respect to elevated temperatures and/or pressures during production of products from or comprising rubber mixtures and/or other organic polymers, such as so-called elastomers. In particular, processing aid coating films may show cracks, that is, the coating layer/film does not have sufficient flexibility, especially upon bending/stretching of a polymer substrate onto which the processing aid coating film/layer has been applied. Additionally or alternative, an often encountered problem in processing aid coating layers obtained from state of the art processing aids may show insufficient wetting of the substrate surface, resulting in a discontinuous coating layer, i.e., a coating layer that does not cover the whole substrate surface area in which is has been applied Hence, this results in the processing aid coating film/layer being delaminated at least partially and/or the processing aid coating film/layer showing cracks, which in turn leads to an insufficient overall demolding/anti-tack/anti-stick effect of the processing aid coating film or layer.

### Object

The object of the disclosure is to provide a processing aid that overcomes the problems of state of the art processing aids at least partially. In particular, one aspect of the present disclosure therefore is directed to processing aids that may be applied in the form of a processing aid coating film (or coating layer) that provides for a coating layer (or coating film), in particular a flexible coating layer (or coating film), that results in a good anti-tacking/anti-sticking/demolding/lubricant/separation effect (for short, in the sense of the disclosure: anti-tack effect), in particular even for surfaces that are flexible, such as a rubber and/or elastomer surface, and/or for production processes for producing products from or comprising rubber mixtures and/or other organic polymers, for example for producing so-called elastomers and that preferably demonstrates its effectiveness regardless of specific process parameters such as temperature, heating and cooling rates, pressures, atmospheres, and/or other unwanted process parameters such as deviations from target values and even contamination of substrate surfaces.

### SUMMARY

The disclosure therefore relates to a processing aid, in particular to a film forming processing aid, and further in particular to a processing aid for forming a processing aid coating layer, in particular an anti-adhesive coating film on a substrate, and/or for acting as a release agent and/or a demolding agent and/or anti-tack agent, and/or an anti-friction agent, and/or a product separation agent and/or a lubricant, in particular when applied to the surface of a substrate in form of a processing aid coating layer. The processing aid of the disclosure comprises at least one water-soluble polymer, at least one surfactant, and at least one plasticizer.

According to a preferred embodiment, the processing aid coating film obtained or obtainable with a processing aid according to embodiments of the disclosure provides its preferred anti-adhesive properties, such as a good anti-tacking/anti-sticking/demolding/lubricant/separation effect, even if the coated substrate undergoes elevated pressure and/or tensile stresses and/or any further mechanical and/or thermal stress.

Formation of a processing aid coating film comprises the steps of a) dissolving and/or dispersing film-forming polymers—that are part of the processing aid in the form of an active ingredient—in a suitable solvent system or diluent, i.e., hence, diluting the processing aid master batch, usually by adding a diluent, such as water, to the processing aid master batch, and dissolving and/or dispersing the active ingredients of the processing aid master batch so that a suitable processing aid dilution is obtained, b) uniformly coating the surface of the substrate with said processing aid dilution so that a processing aid dilution layer is obtained on the substrate, and c) evaporating the diluent to form a preferably continuous and/or coherent and/or adherent processing aid coating layer. The design and composition of the resulting processing aid coating layer, including suitable choice of the polymer type(s), plasticizer(s), and optionally additive(s), are tailored to achieve specific functional objectives while ensuring uniformity and reproducibility in the coating process.

In the scope of the present disclosure, the following definitions apply:

As also detailed further above, a processing aid in the sense of the disclosure is a processing aid for producing products from or comprising rubber mixtures and/or other organic polymers, for example for producing so-called elastomers. The processing aid may be in the form of a master batch in which the active ingredients of the processing aids are provided in a high concentration, that is, which comprises at most 20 wt % in liquids, including diluent(s) such as water, and the processing aid master batch may even be provided in the form of a powder that comprises liquid components only in absorbed form. However, the processing aid may be provided in a more diluted form, that is, comprising more than 20 wt % of liquid, and in particular diluent(s), such as water. When reference is made to the content of active ingredients and their percentage, it is understood that unless stated explicitly otherwise, percentages relate to the sum of the active ingredients, without taking into account any diluent(s), such as water, present. In that respect, it is also pointed out that processing aid master batch and processing aid dilution differ from each other only in terms of their respective liquid contents. Hence, when reference is made to a processing aid, it is understood that this refers to any form of processing aid, regardless from the degree of dilution of the active ingredients. In particular, processing aid is, in the scope of the disclosure, a generic term for both the processing aid master batch and the processing aid dilution.

It is understood that the processing aid of the disclosure comprises active ingredients, that is, ingredients that ensure that the processing aid and/or the processing aid coating layer has/have the desired anti-tack and/or anti-adhesive and/or release agent and/or demolding agent and/or anti-friction agent, and/or product separation agent and/or lubricant properties. Further, the processing aid may comprise further ingredients, in particular, a diluent or a mixture of diluents. The latter do/does not influence the processing aid coating layer properties with respect to anti-tack and/or anti-adhesive and/or release agent and/or demolding agent and/or anti-friction agent, and/or product separation agent and/or lubricant properties. Generally, within the scope of the disclosure, when reference is made to active ingredients, this refers to the ingredients of the processing aids without taking into account any amount of diluent present. In particular, generally, when reference is made to weight percentages, this refers to the weight percentages with respect to the total of active ingredients, without taking into account any diluent present. Further, generally, if not stated explicitly otherwise, percentages are indicated as percentages in weight.

Further, in the scope of the disclosure, an alcohol is understood as referring to an organic compound that has at least one hydroxyl group that is bound to a carbon atom, wherein preferably the at least one hydroxyl group is bound to a saturated carbon atom. An ester is understood to refer to an organic compound of general formula R—COO—R′, with both R and R′ being organyl groups that may be the same group or different from each other. Esters in the sense of the disclosure have often been derived from an acid, in particular an organic acid, and the hydrogen atom of at least one of the acidic hydroxyl group (—(OH) has been replaced by an organyl group, such as R or R′. Esters derived from an organic acid may generally be understood to comprise functional group —COOR, with R being a carbonyl group.

Thus, in the sense of this disclosure, esters also refer to a mixture of mono fatty acid esters of glycerol, mainly stearic and/or palmitic acids, preferably with varying amounts of di- and tri-fatty acid esters of glycerol, and that may contain at least 40% glycerol-1-(palmitate) and/or glycerol-1-(stearate). In particular, a mixture of compounds known as glycerol monostearate, that may be understood as a mixture of mono-fatty acids of glycerol, in particular of stearic acid and palmitic acid, that comprises at least 40% of glycerol-1-palmitate and/or -stearate, may be used. Such a product may be obtained by esterification of a mixture of stearic and palmitate acid with glycerol. According to the disclosure, such a product may be called GMS for short.

A surfactant is an organic compound and decreases the surface tension and/or the interfacial tension between different phases, for example between different liquids and/or between a liquid and a solid. In the sense of the disclosure, an interface is understood to refer to a boundary surface that exists between two substances with different properties, such as between liquids and solids, liquids and liquids, and liquids and gases. Surfactants generally enhance performance by performing functions such as acting as a detergent, emulsifying, dispersing, wetting, and penetrating at this interface.

In the scope of the present disclosure, a plasticizer is a substance that is added to the processing aid to provide for an increased flexibility of the processing aid coating film.

A biopolymer, in the sense of the disclosure, is understood to relate to a polymer that has been synthesized by a living organism and/or a derivative of such a polymer, and is understood to encompass all organic polymer materials synthesized by a living organism and their respective derivatives. In particular, a biopolymer within the sense of the disclosure may refer to a lignin or a derivative of lignin, such as lignin sulphonate, and/or starch and/or a derivative thereof, and/or cellulose and/or a derivative thereof, and/or a polysaccharide and/or a derivative thereof, such as starch and/or a derivative thereof and/or cellulose and/or a derivative thereof, such as, but not being limited to, hydrophobic ethyl nanocellulose, and/or algin and/or a derivative thereof and/or gum arabic and/or a derivative thereof, guar gum and/or a derivative thereof, and/or xanthan gum and/or a derivate thereof, and any combinations thereof. However, this is by no means to be understood as an exhaustive list of suitable biopolymers and other biopolymers might be used as well.

In the scope of the disclosure, a carboxylic acid is understood as a generic term for fatty acids, resins acids, and naphthenic acids. Salts of carboxylic acids are often used as active ingredients for processing aids that are used for forming an anti-adhesive coating film on a substrate and/or for acting as a release agent and/or a demolding agent and/or anti-tack agent, and/or an anti-friction agent, and/or a product separation agent and/or a lubricant, in particular in productions processes for products from or comprising rubber mixtures and/or other organic polymers, for example for producing so-called elastomers. In particular, the carboxylic acid salt may be a monovalent salt, in which case this salt may also be referred to as a soap, as a water-soluble soap or as a water soluble salt. A monovalent carboxylic acid salt, in the sense of the disclosure, is understood to refer to a salt of a carboxylic acid that comprises, as cation, a monovalent cation.

The cation, in that case, may comprise K⁺ and/or Na⁺ and/or NH₄⁺, for example. Further, the carboxylic acid salt may be polyvalent, in which case the respective salt may also be referred to as a water-insoluble soap, or a water-insoluble metal soap. Polyvalent carboxylic acid salts in the sense of the disclosure refer to salts that comprise, as cations, polyvalent cations. Particularly well known are divalent carboxylic acid salts, that is, with cations Ca²⁺ and/or Mg²⁺, for example, and generally, with divalent cations.

A fatty acid is generally understood to be a mostly unbranched aliphatic monocarboxylic acid. Resin acids are a heterogeneous group of organic acids which occur, for example, in natural resins. Naphthenic acids are understood here to mean carboxylic acids which comprise at least one cyclopentane and/or cyclohexane group with at least one alkyl substituent. These groups of carboxylic acids may also be generally referred to as “soap-forming carboxylic acids” in the context of the present disclosure.

In the context of the present disclosure, a monovalent carboxylic acid salt may also be referred to as a water-soluble metal soap and is generally, without being restricted to any of the specific examples and embodiments of the disclosure, an alkali salt of one of the aforementioned carboxylic acids, in particular a sodium salt and/or potassium salt, and/or an ammonium salt of one of the aforementioned carboxylic acids, for example a fatty acid, or a mixture of these substances. The monovalent carboxylic acid salt can also be referred to as a water-soluble soap, a soap, or an alkali soap. In particular, the term “water-soluble soap” encompasses a sodium salt and/or potassium salt and/or an ammonium salt of a fatty acid, for example a sodium stearate and/or potassium stearate, and/or a sodium oleate and/or potassium oleate, or mixtures thereof.

Stearates belong to the group of carboxylic acid salts, in particular, fatty acids salts, and, in the context of the present disclosure, comprise the salts of selected fatty acids. In the context of the present disclosure, a stearate is in particular generally understood to refer to salts of the alkanoic acids, margaric acid, palmitic acid, and/or stearic acid, as generally, stearates provided for technical use are provided as a blend and may comprise, as technical grade ingredients, apart from the main component (a stearate in the strict chemical sense) further fatty acids salts as minor components. A stearate in the sense of the disclosure thus comprises a salt of hexadecanoic acid (n-hexadecanoic acid), heptadecanoic acid (n-heptadecanoic acid), octadecanoic acid (n-octadecanoic acid), and/or mixtures thereof. A stearate preferably contains a salt of octadecanoic acid as a main constituent, meaning that at least 10 wt %, preferably at least 20 wt %, and preferably more than 50 wt % of the stearate comes in the form of a salt of octadecanoic acid. The alkanoic acids contained in the stearate are usually used in combination with different metals, such as calcium, zinc, magnesium, sodium, aluminum, and lithium. In this case one speaks of calcium stearate, zinc stearate, magnesium stearate, sodium stearate, aluminum stearate, and lithium stearate, among others. Technical grade calcium stearate, for example, can often contain not only calcium stearate but also other calcium salts of higher fatty acids, for example calcium palmitate.

This similarly applies to the other metal stearates. That is, the same or similar systematic can be applied to describe other metal stearates. It is understood that the same applies to other carboxylic acid salts as well.

The water-insoluble carboxylic acid amide, for example a diamide, preferably a diamide of one or more long-chain carboxylic acids, preferably a diamide of a long-chain alkanoic acid, in particular a long-chain unbranched, more particularly a long-chain unbranched and saturated alkanoic acid, most preferably ethylene distearylamide (also abbreviated as EBS), preferably comes in the form of a waxy, per se also meltable component, and is also able to act as a release agent component, in particular together with the metal soap and/or the water-soluble soap, if present. The water-insoluble carboxylic acid amide preferably has 35 to 40 carbon atoms and/or a molar mass of less than 1000 g/mol. The water-insoluble carboxylic acid amide can also have a desirable effect on foam formation, i.e., contribute to a reduction in foaming in the processing aid resulting from the formulation. Generally, in the scope of the disclosure, the water-insoluble carboxylic acid amide may be a diamide, preferably a diamide of a long-chain carboxylic acid, preferably a diamide of a long-chain alkanoic acid, in particular of a long-chain unbranched alkanoic acid. A preferred embodiment of the carboxylic acid amide is ethylene distearylamide, which is often also referred to as ethylene bis(stearamide) and abbreviated “EBS”. Ethylene distearylamide is a preferred embodiment of a waxy meltable component and cooperates particularly well with stearates, for example.

In the sense of the disclosure, an inorganic powder component is a component that comprises particles, with particles also encompassing particles in the agglomerated form. The inorganic powder component is preferably selected from the group consisting of a layered silicate or an organically modified layered silicate, such as bentonite, montmorillonite, smectite, stevensite, hectorite, sepiolite, talc, a carbonate, for example CaCO₃, a zeolite, a kaolin and/or a silicic acid also known as silica. A inorganic powder component may also be referred as a powder component comprising inorganic phases or one inorganic phase or a plurality of inorganic phases, in particular inorganic, in particular preferably inorganic non-metallic phases, and may, from a more functional point of view, be understood a separator component which is based on an inorganic phase and can be added as a powder component in the context of the disclosure. More particularly, these inorganic phases can be layered silicates, as mentioned above.

The processing aid according to the disclosure offers several benefits. For example, in a surprisingly simple manner, according to disclosure, a processing aid may be obtained that has the desired anti-tack properties (as disclosed and discussed in details further above, such as anti-adhesive and/or release agent and/or demolding agent and/or anti-tack agent, and/or anti-friction agent, and/or product separation agent and/or lubricant properties), and that may also be also suited to be applied onto substrates, in particular, to substrates of products from or comprising rubber mixtures and/or other organic polymers, for example for producing so-called elastomers, even for temperatures ranging from 5° C. to 350° C. (in particular ambient temperatures) and/or 25° C. to 200° C., (in particular substrate temperatures), which are typical temperatures during storage, handling and processing of the substrates and/or the processing aid and/or the processing aid coating layer. Hence, according to the disclosure, the processing aid and/or the processing aid coating layer show the desired properties and functionalities even when applied onto a flexible substrate, at elevated temperatures of up to about 350° C. ambient temperature, and/or for rather low ambient temperatures of only 5° C. or, during storage, even less, and/or upon bending and/or flexing the substrate and/or under elevated pressures.

In particular, inventors found that a processing aid that comprises, as active ingredients, at least one water-soluble polymer, at least one surfactant, and at least one plasticizer, provides for a flexible processing aid coating film/layer, especially when applied to the surface of a product from or comprising rubber mixtures and/or other organic polymers, for example for producing so-called elastomers that has an excellent separation effect (which may also be referred to as anti-tacking or anti-sticking, and which may also be used for release agents, and/or demolding agents, and/or lubricants and/or anti-friction agents, or, for short, anti-tack effect in the sense of the disclosure). In that way, storage and/or further processing of these products is enabled in a simple and efficient manner. Furthermore, inventors found that surprisingly, no further active ingredients need to be present within the processing aid of the disclosure in its simplest embodiment.

Inventors found that this may be due to the use of at least one plasticizer. By adding a suitable plasticizer, it has been found that the desired anti-adhesion/anti-tack properties of the applied processing aid coating layer may be obtained, while ensuring, at the same time, that the properties of the coated substrate are not negatively affected.

Inventors further believe that the at least one plasticizer of the processing aid of the disclosure might also result in changes in the rheologic properties of the processing aid master batch and/or its further processing properties. That is, it is assumed that the processing aid master batch according to embodiments of the disclosure, that is, comprising at least one plasticizer, shows less foam formation, for example when being pumped and/or otherwise transferred to, from or between different production equipment. Also, surprisingly, it has been found that even if residue of the processing aid remains within production equipment, this does not result in sticking or blocking of components and/or products that come into contact with said residues. Rather, the residues may even act as sort of a lubricant.

The at least one plasticizer of the processing aid of the disclosure is believed to shift the thermoplastic properties range of a polymer or polymer mixture to a lower temperature range. This results in the respective polymer or polymer mixture to show desired “more elastic” properties, resulting in the processing aid and/or processing aid coating layer of the disclosure, in the desired flexible coating layer that ensures the good anti-tack effect. Further, the plasticizer also results in lowering the glass transition temperature of the polymer or polymer mixture. This is assumed to be due to the rather small molecules of (a) suitable plasticizer(s) to act as spacers between the long polymer chains of the respective polymer(s), that is, in the sense of the disclosure, the at least one water-soluble polymer. In that way, the polymer chains are at a greater distance from each other, which in turn enhances their mobility and/or flexibility with respect to each other.

The water-soluble polymers known to be suited in processing aids for forming processing aid coating layers that have the desired anti-tack effect tend to form rather ordered structures, due to dipole-dipole interaction between adjacent polymeric chains. The glass transition temperature of the polymers is generally defined as the temperature at which polymers that are at least partially amorphous transition from a liquid or elastic, flexible state to a brittle, more “glassy”, state, and may even be used to identify a given polymer. Without plasticizers, these polymers tend to form a dense structure, resulting in even at least partially crystalline, highly ordered regions within the polymer. These at least partially crystalline regions may also result in case a polymer is heated above the glass transition temperature, followed by cooling down. However, as explained further above, plasticizers may act as spacers between polymer chains or structures, thus preventing the formation of dense regions within the polymer that tend to crystallize.

Processing aids according to the state of the art are known to comprise, as an active ingredient, at least one water-soluble polymer, which preferably is polyvinyl alcohol, a common water-soluble polymer in the art. However, inventors found that coating layers obtained from such processing aids do not exhibit the amount of high flexibility that is needed. In particular, the coating layers/films of such processing aids exhibit cracks and/or delamination, especially upon bending of the flexible substrate and/or its shrinking or expansion during storage and/or further processing of polymeric and/or rubber and/or elastomeric product.

This problem can, however, be solved in a very quick and efficient manner by adding a further component that results in enhanced flexibility of the processing aid coating layer. In the scope of this disclosure, this further component is referred to as plasticizer, as explained further above.

This is particularly helpful, as this allows for using, as a water-soluble polymer, further polymers other than polyvinyl alcohol (PVA). In particular, for the processing aid according to embodiments of the disclosure, while PVA may be present as water-soluble polymer, it may, according to embodiments, also be dispensed with.

Generally, with respect to the processing aid of the disclosure, at least one water-soluble polymer is present, but it is also possible and may be preferred that the processing aid of the disclosure comprises more than one water-soluble polymer. Water-soluble polymers that may be present in the processing aid according to the disclosure include, but are not limited to, polyvinyl alcohol (PVA) and/or starch and/or derivates of starch, and/or further biopolymers, such as lignin, and/or derivatives of lignin, such as lignin sulphonate, and/or a polysaccharide and/or a derivative thereof, such as starch and/or a derivative thereof and/or cellulose and/or a derivative thereof, such as, but not being limited to, hydrophobic ethyl nanocellulose, and/or algin and/or a derivative thereof and/or gum arabic and/or a derivative thereof, and/or xanthan gum and/or a derivate thereof, and any combinations thereof. As stated further above, in some cases, PVA may even be dispensed with as active ingredient of the processing aid of the disclosure, however, it may be preferred that it is at least present in minor amounts. This is due to the presence of the at least one plasticizer that enhances flexibility of the resulting processing aid coating film, such that a film with enhanced adherence to the substrate surface and/or without crack formation is obtained. From a functional point of view, the at least one water-soluble polymer may be regarded as a film former or film-forming component.

According to an embodiment of the processing aid, it comprises 20-80% in weight of a water-soluble polymer or, in case the processing aid comprises more than one water-soluble polymer, 20-80% in weight of water soluble polymers. In the sense of the disclosure, when reference is made to the composition of the processing aid, especially to the amount of active ingredient(s) present, the content is generally given as % in weight with respect to the weight of active ingredients, that is, without taking into account any diluent(s).

According to an embodiment, the processing aid comprises at least 20% in weight of a water-soluble polymer or, in case the processing aid comprises more than one water-soluble polymer, at least 20% in weight of water soluble polymers. This is helpful to provide for good film-forming properties of the processing aid of the disclosure when applied to the surface of a product from or comprising rubber mixtures and/or other organic polymers, for example for producing so-called elastomers. According to a further embodiment, the processing aid comprises at least 25% in weight of a water-soluble polymer (or several water-soluble polymers). According to a further embodiment, the processing aid comprises at least 30% in weight of a water-soluble polymer (or several water-soluble polymers). However, to avoid the formation of brittle films, the content in water-soluble polymer(s) should not be too high and may, according to an embodiment, generally, without being limited to any of the embodiments of the disclosure, be at most 80% in weight, or even less, for example, at most 70% in weight, or even at most 60% in weight of even lower.

It has surprisingly been found that the addition of at least one ester of a fatty acid and a polyol, in particular glycerol monostearate, not only acts as a nonionic emulsifier within the aqueous coating composition, but additionally reduces the gliding friction and surface tackiness of the dried film, wherein the lipophilic stearate part preferentially orients towards the film surface, thereby creating a lubricating boundary layer that improves the lubricant and glide properties of said dried film.

According to an embodiment, therefore, the processing aid comprises, with respect to the weight of the active ingredients, 20-80% of water-soluble polymer(s). All ranges inbetween these upper and lower limits are also possible.

As stated above, generally, without being restricted to any of the specific embodiments or examples described within the scope of the present disclosure, only one water-soluble polymer need to be present in the processing aid of the disclosure. It is, however, possible and may even be preferred that the processing aid of the disclosure comprises more than one water-soluble polymer. For example, the processing aid of the disclosure may comprise starch and/or a derivative thereof, which may even totally replace PVA that has been a commonly used water-soluble polymer in processing aids of the state of the art. This may be helpful in terms of reducing production costs and/or providing for a sustainable resource, while maintaining the performance of the processing aid and the corresponding processing aid coating layer.

In case the at least one water-soluble polymer comprised by the processing aid is starch, it is noted there that care has to be taken that the plasticizer and its content in the processing aid may have to be adjusted taking into account that film formation may may strongly depend on the composition of the starch, for example, the ratio of amylose to amylopectin. For example, hydroxypropylated high-amylose starch yields films with higher tensile strength and elongation than those from waxy (low-amylose) starch. Further, it has been found that hydroxypropylated starch from pea starch that comprises about 35% in weight amylose produces transparent, flexible films, in which case plasticizers need only be added in rather small amounts, whereas native starch requires a higher amount of plasticizer(s) to avoid brittleness. The amylose vs. amylopectin ratio in the starch is another helpful factor. High-amylose starch (e.g. more than 50% in weight amylose) tends to form stronger, denser films which can, nevertheless tend to be brittle, while waxy starch with only minor amount of amylose that may even be 0% amylose gives very elastic but low-strength, tacky films. Hydroxypropylation mitigates the extremes of both types—it plasticizes high-amylose chains and reduces amylopectin retrogradation. Taking HPS therefore might be a good compromise in case the bioplymer is starch or a derivate thereof.

The processing aid comprising more than just one water-soluble polymer may also be helpful in terms of reducing the crystallinity of a polymer and/or its tendency to formation of highly ordered regions. In that case, the processing aid and/or the processing aid coating layer may comprise interpenetrating networks, that is, be understood as a polymer blend. In that case, the blend may also be designed such that one component forms a continuous phase that may form hydrogen bonds to the substrate surface, while a further, in that case, hydrophobic phase interpenetrates the first polymer phase and protects it from dissolving. Hence, such a film comprising two water-soluble polymers may be of particular interest.

The addition of the plasticizer in the processing aid of the disclosure therefore allows for the at least partial substitution of PVA by a biopolymer, such as lignin and/or a derivative of lignin, such as lignin sulphonate and/or a polysaccharide and/or a derivative thereof, such as starch and/or a derivative thereof and/or cellulose and/or a derivative thereof, such as, but not being limited to, hydrophobic ethyl nanocellulose, and/or algin and/or a derivative thereof and/or gum arabic and/or a derivative thereof, and/or xanthan gum and/or a derivate thereof, and any combinations thereof, and thus allows for a more sustainable product.

According to a further embodiment, the processing aid comprises PVA as a water-soluble polymer, preferably in addition to a first water-soluble polymer other than PVA, with the first water-soluble polymer preferably being a biopolymer, and more preferably lignin and/or a derivative of lignin, such as lignin sulphonate, and/or a polysaccharide and/or a derivative thereof, such as starch and/or a derivative thereof and/or cellulose and/or a derivative thereof, such as, but not being limited to, hydrophobic ethyl nanocellulose, and/or algin and/or a derivative thereof and/or gum arabic and/or guar gum and/or a derivative thereof, and/or xanthan gum and/or a derivate thereof, and any combinations thereof.

According to prior art, PVA itself is already considered mostly biodegradable, while all of the biopolymers mentioned are considered fully biodegradable. This means that a product can be obtained that may be described as sustainable and, in the simple form described, may also be considered free of SPM (Synthetic Polymer Microparticles).

According to an embodiment, the plasticizer comprises an alcohol, in particular a polyhydric alcohol, and/or an ester and/or any combination thereof. Particularly well suited are, for example, glycerol, sorbitol, propylene glycol and polypropylene glycol, maltitol, mannitol, and low-molecular poly(ethylene glycol. Any of these may be taken as plasticizer, either alone or in any combination with a further plasticizer, such as the beforementioned ones to fine-tune film hardness/brittleness vs. flexibility, as explained in detail below.

According to an embodiment, the processing aid comprises, with respect to the weight of the active ingredients, 5-40% of plasticizer(s). That is, according to an embodiment, the processing aid generally comprises at least one plasticizer, but may also, generally, comprise more than one plasticizer. The amount of plasticizer present in the processing aids refers, in any case, to the total of plasticizer(s) present, that is, to the sum of plasticizer(s) comprised by the processing aid in case it comprises more than one plasticizer.

It has been found very efficient in case the plasticizer shall be used under various different process conditions to use more than one plasticizer. That is, according to an embodiment, a balance between film-forming properties and film flexibility may be achieved by carefully selecting properties and respective amounts of at least two plasticizers, and even more, if necessary. While, as has been explained further above, at least one plasticizer is a mandatory component and improves the properties of the coating layer obtained with the processing aid according to the disclosure, care has to be taken to ensure that the anti-tack properties of the processing aid coating layer and surfaces coated with it are obtained. This is achieved by carefully choosing the respective plasticizer(s) and its/their respective amount present within the processing aid of the disclosure. For example, while glycerol is a plasticizer that is very effective in ensuring a high flexibility of the processing aid coating layer, processing aid coating layers may tend to get tacky, that is, may show a high surface friction due to its hygroscopicity if it is added in a too high amount. It may therefore be preferred to blend glycerol and/or replace it by sorbitol, which is less hygroscopic and, when used in combination with glycerol, yields a superior balance of flexibility and strength. In any case, the amount of plasticizer(s) present therefore has to be carefully adjusted and preferably is in the range indicated above.

According to an embodiment, the processing aid comprises, with respect to the weight of active ingredients, 5-40% of surfactant(s). That is, the processing aid comprises generally at least one surfactant, but may also comprise two or more surfactants. The indicated content in surfactant(s) refers to the total of surfactants present, whether the processing aid comprises only one surfactant or more than one.

According to an embodiment, the processing aid comprises a content of a surfactant or surfactants of at least 5% in weight of active ingredients. Inventors found that this in helpful to provide for a good wetting of the processing aid when applied to the surface of a product from or comprising rubber mixtures and/or other organic polymers, for example for producing so-called elastomers. According to an embodiment, the content in surfactant(s) is at least 10% in weight of active ingredients, or even at least 15% in weight of active ingredients, or even at least 20% in weight of active ingredients to ensure wetting and/or to avoid foam-formation, especially formation of massive amounts of foam, while using the processing aid. However, a too high content in surfactant(s) may be detrimental to film formation, and according to an embodiment, the content in surfactant(s) may be limited and may, by way of example, be at most 40% in weight of active ingredients or even lower, for example at most 30% in weight of active ingredients.

According to an embodiment, the surfactant or the two or more surfactants have a hydrophilic-lipophilic balance (HLB) between 3 and 20, preferably between 6 and 18, more preferably between 6 and 15. In case more than one surfactant is present, the HLB indicated refers to the HLB of the mixture of the surfactants present. According to a further embodiment, in case more than one surfactant is present, the processing aid may comprise an anionic surfactant and a non-ionic surfactant, or several anionic surfactants, or several non-ionic surfactants, or a any combination thereof.

According to a further embodiment, the processing aid comprises at least one carboxylic acid salt, preferably a metal carboxylic acid salt. According to a preferred embodiment, the at least one carboxylic acid salt is a water-soluble carboxylic acid salt, and may therefore also be referred to, for example, a water-soluble soap. As cations, the carboxylic acid salt may comprise potassium ions or sodium ions or a mixture of both. The carboxylic acid salt may, according to a preferred embodiment, be a stearate, such as a potassium stearate or a sodium stearate, or a mixture of both. While the processing aid may comprise several carboxylic acid salts, in case only one such salt is present, it is preferable a monovalent carboxylic acid salt, or, in other words, a soap (or water-soluble salt, or water-soluble metal salt).

While the at least one carboxylic acid salt is not a mandatory active ingredient of the processing aid of the disclosure, it may be preferred to add it to the processing aid, as it may lower the surface tension of the processing aid, in particular for the processing aid dilution, and ensure a good dispersion of the active ingredients within the processing aid dilution. Further, it may also act as a spacer within the thus-obtained processing aid coating layer, ensuring good anti-sticking properties and/or lubrification of the film, and, thus, the coated substrate surface. Hence, in the sense of the disclosure, the carboxylic acid salt(s) may be, from a functional point of view, be regarded as both a release agent component and a spacer.

According to a preferred embodiment of the processing aid that comprises a carboxylic acid salt, the processing aid comprises a further carboxylic acid salt, wherein one carboxylic acid salt is a monovalent carboxylic acid salt, and wherein the further carboxylic acid salt is a polyvalent carboxylic acid salt. That is, according to an embodiment, the processing aid may comprise both a water-soluble soap and a water-insoluble soap. In particular, the processing aid according to embodiments may comprise a calcium stearate and a potassium oleate, by way of example, or another combination of a monovalent and a polyvalent, in particular, a divalent, carboxylic acid salt.

Water-insoluble carboxylic acid salts (polyvalent carboxylic acid salts) may be added, as they act as a release agent component within the processing aid, and also in the processing aid coating film.

According to an embodiment, the processing aid comprises, with respect to the weight of active ingredients, up to 70% carboxylic acid salt(s). As has already been pointed out further above with respect to other active ingredients and the respective amounts in which they are present, this refers to the total of carboxylic acid salts present, in case the processing aid comprises more than just one carboxylic acid salt.

Special carboxylic acid salt(s) or mixtures thereof may be selected as components of the processing aid, in particular such carboxylic acid salt(s) that is/are stable even at high process temperatures. The inventors have found that this allows the application-specific properties of processing aid to be adjusted in a robust manner.

According to a further embodiment of the disclosure, the processing aid may comprise a water-insoluble carboxylic acid amide. This may be particularly preferred to enhance release agent properties of the processing aid or rather, the processing aid coating layer in a substrate. The carboxylic acid amid may also act as a spacer in the processing aid coating layer and thus provide for further enhancement of the anti-tack effect of the coating layer. Hence, in the context of the disclosure, the carboxylic acid amide may also, from a functional point of view, be regarded as a spacing agent.

According to a yet further embodiment, the processing aid may also comprise at least one inorganic powder component. Such an inorganic powder component may be added for enhancing lubrification, and it also acts as a spacer between adjacent surfaces, thus resulting in a very good anti-tack effect.

Generally, the processing aid may also comprise further active ingredients, which are commonly added in minor amounts, and referred to as “additives”. That is, the processing aid according to embodiments may comprise at least one additive from the group of a defoamer, that is, an additive, usually a surfactant, that reduces the foam-forming tendency in a dispersion and/or suspension, a biocide, a rheology additive, a phase change material (or PCM), a buffer, a corrosion inhibitor, a conductivity additive and/or a water softener, and/or any combination thereof.

### EXAMPLES

The processing aid of the disclosure will now be explained in more detail with reference to examples as provided in the following table. The respective amounts of ingredients present (in that case, active ingredients) are given in weight percent, with respect to the weight of the active ingredients, not taking into account any diluent(s).

| | | Example No. | | | | | | | |
|---|---|---|---|---|---|---|---|---|---|
| | | 1 | 2 | 3 | 4 | 5 | 6 | 7 | 8 |
| Water-soluble | PVA #1 | 39 | 14 | | 37 | 41 | 36 | 28 | 28 |
| polymer(s) | PVA #2 | | 14 | | | | | | |
| | Algin | | | | | | | | |
| | Starch | | | 37 | | | 1 | 9 | 1 |
| | Gum arabic | | | | | | | | |
| | Lignin | | 13 | | | | | | 11 |
| | Xanthan gum | | | | | | | | |
| Carboxylic | Ca-Stearate #1 | | | | | | | | |
| acid salt(s): | Ca-Stearate #2 | 29 | 27 | 27 | 27 | 29 | 27 | 27 | 24 |
| Polyvalent/ | Mg-Stearate | | | | | | | | |
| water-insoluble | | | | | | | | | |
| Carboxylic | Na-Stearate | 7 | | | | | | | |
| acid salts: | Na-Oleate | | | 4 | 4 | 5 | 4 | 4 | 4 |
| Monovalent/ | | | | | | | | | |
| water-soluble | | | | | | | | | |
| Plasticizer(s) | Glycerol | | 9 | 9 | 9 | | 8 | 8 | 8 |
| | Polypropylene glycol | | | | | | 1 | 1 | 1 |
| | Propylene glycol | | | | | | | | |
| Surfactant(s) | Anionic surfactant | 3 | 3 | 3 | 3 | 3 | 3 | 3 | 3 |
| | Non-ionic surfactant #1 | 9 | 8 | 8 | 8 | 9 | 8 | 8 | 8 |
| | Non-ionic-surfactant #2 | 10 | 9 | 9 | 9 | 10 | 9 | 9 | 9 |
| Further | Water softener | | | | | | 1 | 1 | 1 |
| ingredients/additives | Biocide | 2 | 2 | 2 | 2 | 2 | 2 | 2 | 2 |
| Total (% in weight) | | 100 | 100 | 100 | 100 | 100 | 100 | 100 | 100 |

1. A processing aid, comprising at least one water-soluble polymer, at least one surfactant, and at least one plasticizer.

2. The processing aid according to claim 1, wherein the at least one water-soluble polymer comprises a biopolymer.

3. The processing aid according to claim 1, further comprising PVA as a further water-soluble polymer.

4. The processing aid according to claim 1, comprising, with respect to the weight of the active ingredients, 20-80% of water-soluble polymer(s).

5. The processing aid according to claim 1, wherein the plasticizer comprises an alcohol an ester, and/or any combination thereof.

6. The processing aid according to claim 1, comprising, with respect to the weight of the active ingredients, 5-40% of plasticizer(s).

7. The processing aid according to claim 1, comprising, with respect to the weight of active ingredients, 5-40% of surfactanct(s).

8. The processing aid according to claim 1, further comprising at least one carboxylic acid salt.

9. The processing aid according to claim 8, comprising a further carboxylic acid salt, wherein one carboxylic acid salt is a monovalent carboxylic acid salt, and wherein the further carboxylic acid salt is a polyvalent carboxylic acid salt.

10. The processing aid according to claim 8, comprising, with respect to the weight of active ingredients, up to 70% of carboxylic acid salt(s).

11. The processing aid according to claim 1, further comprising a water-insoluble carboxylic acid amide.

12. The processing aid according to claim 1, further comprising at least one inorganic powder component.

13. The processing aid according to claim 1, comprising at least one additive from the group of a defoamer, a biocide, a rheology additive, a phase change material (PCM), a buffer, a corrosion inhibitor, a conductivity additive, and/or a water softener.

14. The processing aid of claim 1, wherein the processing aid is for forming an anti-adhesive coating film on a substrate and/or for acting as a release agent and/or a demolding agent and/or anti-tack agent, and/or an anti-friction agent, and/or a product separation agent and/or a lubricant.

15. The processing aid of claim 2, wherein the biopolymer includes a lignin, a derivative of lignin, a polysaccharide, and/or a derivative of polysaccharide.

16. The processing aid of claim 15, wherein the polysaccharide includes starch and/or a derivative thereof, cellulose and/or a derivative thereof, algin and/or a derivative thereof, gum arabic and/or a derivative thereof, guar gum and/or xanthan gum and/or a derivate thereof, and any combinations of the aforementioned polysaccharides.

17. The processing aid of claim 16, wherein the lignin includes lignin sulphonate, and the cellulose includes hydrophobic ethyl nanocellulose.
